(19) United States
(12) Patent Application Publication
(10) Pub. No.: US 2010/0302900 A1
(43) Pub. Date: Dec. 2, 2010

(54) Autonomously operated marine seismic acquisition system

(75) Inventor: Stig Rune Lennart Tenghamn, Katy, TX (US)

Correspondence Address: Petroleum Geo-Services, Inc., P.O. Box 42805, Houston, TX, 77242-2805, US

(73) Assignee: PGS Geophysical AS

(21) Appl. No.: 12/456,980

(22) Filed: Jun. 25, 2009

Related U.S. Application Data
(60) Provisional application No. 61/217,031, filed on May 26, 2009.

(51) Int. Cl. G01V 1/38

(52) U.S. Cl. 367/20

(57) ABSTRACT

A seismic survey system includes at least one autonomously operated vehicle and at least one seismic energy source associated with the autonomously operated vehicle. The autonomously operated vehicle includes a controller programmed to operate the at least one seismic energy source at selected times and to cause the autonomously operated vehicle to follow a predetermined geodetic path.

### CROSS-REFERENCE TO RELATED APPLICATIONS

Priority is claimed from U.S. Provisional Application No. 61/217,031 filed on May 26, 2009.

### STATEMENT REGARDING FEDERALLY SPONSORED RESEARCH OR DEVELOPMENT

Not applicable.

### BACKGROUND OF THE INVENTION

1. Field of the Invention

The invention relates generally to the field of marine seismic surveying. More specifically, the invention relates to devices for operating marine seismic surveying systems in difficult to access environments.

2. Background Art

U.S. Pat. No. 6,028,817 issued to Ambs describes marine seismic survey systems including separate towing vessels for parts of an entire survey system, for example, one or more seismic sensor streamers or one or more seismic energy sources.

Certain environments, for example, beneath surface ice, can be difficult to access using conventional marine seismic acquisition systems. It is desirable, therefore, to have a system for operating marine seismic survey equipment that is capable of operating in such inaccessible environments.

### SUMMARY OF THE INVENTION

A seismic acquisition system according to one aspect of the invention includes at least one autonomously operated vehicle and at least one seismic energy source associated with the autonomously operated vehicle. The autonomously operated vehicle includes a controller programmed to operate the at least one seismic energy source at selected times and to cause the autonomously operated vehicle to follow a predetermined geodetic path.

A method for seismic surveying according to another aspect of the invention includes moving a first autonomously operable vehicle in a body of water along a predetermined geodetic path. The vehicle tows a seismic sensor streamer. A plurality of second autonomously operable vehicles is moved in a selected pattern with respect to the first vehicle and substantially simultaneously therewith. Each of the second vehicles moves at least one seismic energy source therewith. The at least one seismic energy source on each second vehicle is actuated at selected times. Signals generated by seismic sensors in the sensor streamer are recorded.

A method for seismic surveying according to another aspect of the invention includes moving a plurality of autonomously operable vehicles in a body of water substantially simultaneously in a predetermined pattern with respect to each other along a predetermined geodetic path. Each vehicle tows a seismic sensor streamer therefrom. Each vehicle moves at least one seismic energy source therewith. The at least one seismic energy source on each vehicle is actuated at selected times. Signals generated by seismic sensors in each seismic sensor streamer are recorded.

Other aspects and advantages of the invention will be apparent from the following description and the appended claims.

### BRIEF DESCRIPTION OF THE DRAWINGS

FIG. 1 shows an example of a marine vibrator array coupled to an autonomously operated vehicle.

FIG. 2 shows another autonomously operated vehicle towing a plurality of seismic sensor streamers.

FIGS. 3 and 4 show example arrangements of multiple autonomously operated vehicles.

### DETAILED DESCRIPTION

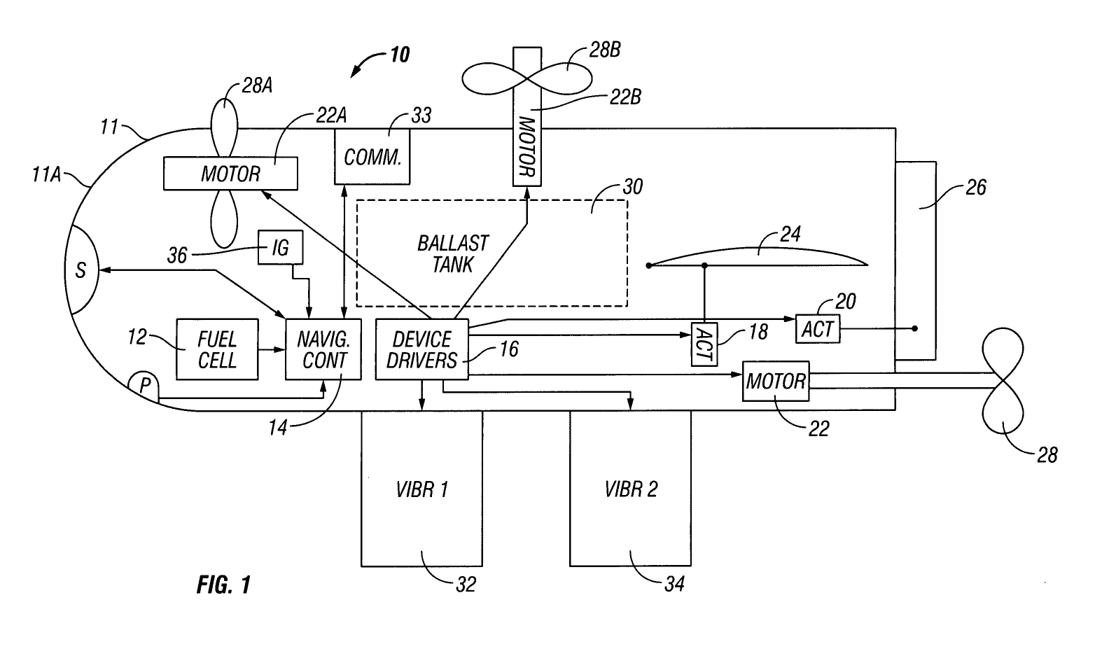

FIG. 1 shows an example of an autonomously operated vehicle (AOV) 10 that is capable of operating in a body of water, for example, below a layer of ice. The AOV 10 may include a hydrodynamically shaped housing 11 that defines a pressure sealed interior chamber 11A. The chamber 11A may include therein a source of electrical power 12 such as batteries, fuel cells or other source of electrical power. In the present example the power source 12 may be hydrogen/oxygen fuel cells. The electrical power may be used to operate certain other devices (explained below) disposed in the chamber 11A. Such devices may include a navigation controller 14, an inertial guidance type position sensor system 36 and device drivers 16.

The chamber 11A may also include or may have adjacent thereto a ballast tank 30 filed with a suitable material to cause the AOV 10 to be substantially neutrally buoyant. It is contemplated that in combination the size of the chamber 11A, the wall thickness of the housing 11 and the sufficiently incompressible material will be used to fill the ballast tank 30 such that the AOV 10 may operate at substantial water depth without being crushed by hydrostatic pressure.

The navigation controller 14 may be a general purpose programmable computer or application specific integrated circuit arrangement, for example. The navigation controller 14 may be initialized at the beginning of a seismic data acquisition operation by communication of the geodetic position to the controller 14. Such communication may be provided by any source of geodetic position information, for example, output of a global positioning system (GPS) receiver (not shown) prior to deployment of the AOV 10. The AOV 10 may be moved to the general vicinity of the seismic acquisition operation on board a transport vessel (not shown). The transport vessel (not shown) may stop at a selected location, and prepare the AOV 10 for deployment. Such preparation may include initializing the navigation controller 14 with the geodetic position measured by the GPS receiver (not shown) at the time the AOV 10 is deployed from the transport vessel (not shown). Alternatively, an initial geodetic position may be pre-programmed into the navigation controller 14, and the AOV 10 may be deployed from such geodetic position. The navigation controller 14 may be pre-programmed with a seismic survey geodetic trajectory. The seismic survey trajectory may include preselected geodetic paths to be followed by the AOV 10 during the seismic survey operation. By having pre-programmed geodetic paths entered into the navigation controller 14, the navigation controller 14 may send control signals to device drivers 16 (explained below) that result in operation of various components that change the direction of motion of the AOV 10. The change in direction of motion of the AOV 10 may be selected to cause the AOV 10 travel along such pre-programmed geodetic paths without the need to detect geodetic position signals from a source of such signals (e.g., GPS) during seismic survey operations.

The device drivers 16 may operate in response to control signals communicated thereto by the navigation controller 14, as explained above. The device drivers 16 may be configured to operate the following components to cause the AOV 10 to move, and to be able to change direction (i.e., steering devices) to move along the pre-programmed geodetic paths. A motor 22, for example, an electric motor may drive a propeller 28 to impart forward or backward motion to the AOV 10. With reference to steering devices, a rudder actuator 20, for example, an hydraulic actuator or motor/worm gear/ball screw combination actuator, may operate a rudder 26 to cause changes in the geodetic direction of travel of the AOV 10. A diving plane actuator 18, which may also be, for example, an hydraulic actuator or motor/worm gear/ball screw combination actuator, may operate a diving plane 24 to cause water depth changes as required in the movement of the AOV 10.

In the present example, the AOV 10 may also include one or more thrusters, including a motor 22A and associated impeller 28A proximate the forward end of the housing 11 to assist in imparting forward and reverse motion. The AOV 10 may also include one or more thrusters including a motor 22B and impeller 28B proximate the center of the longitudinal dimension of the housing 11 to enable maintaining the AOV 10 in a fixed depth position. The thrusters explained above in some examples may be of a type such that they have thrust directions rotatable with respect to the housing 11 in order to increase the manuverability of the AOV 10. Such rotatable thrusters are known in the art.

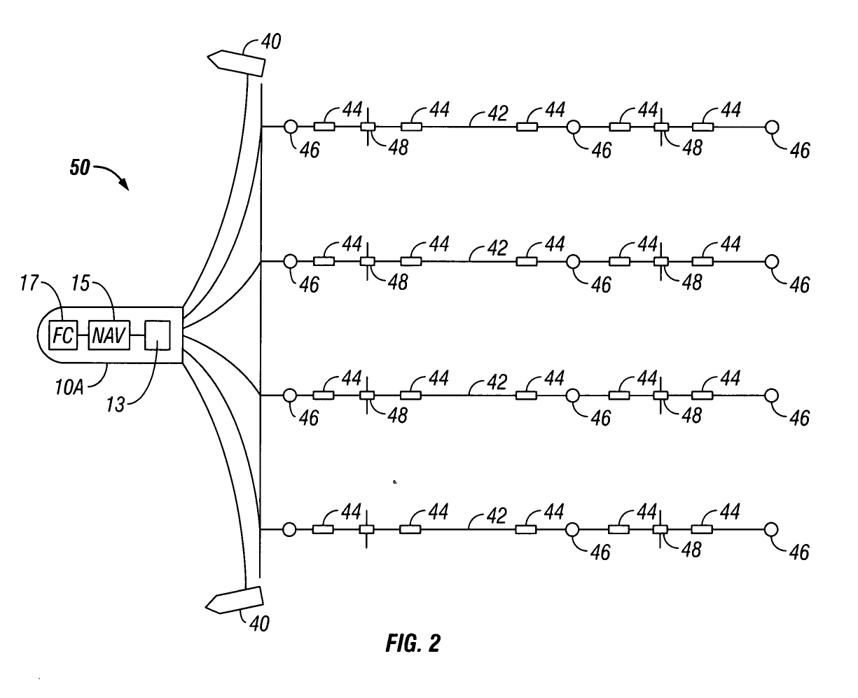

The AOV 10 may include an electromagnetic (e.g., radio) or and/or acoustic communication transceiver 33 disposed in the chamber 11A. The transceiver 33 may enable communication of data from the AOV 10 to the surface above an ice layer, and/or may enable communication between the AOV 10 and similar AOVs of types to be explained below with reference to FIGS. 2, 3 and 4.

Certain sensors may generate signals that cause the navigation controller 14 to change in the path of motion of the AOV 10. Such sensors may include a pressure sensor P in signal communication with the navigation controller 14. The pressure sensor P can generate a signal that directly corresponds to water depth of the AOV 10. An obstacle detection sensor S, for example, an active sonar device, may be disposed near the forward end of the housing 11 such that any obstacles in the path of motion of the AOV 10, for example, subsurface ice or rock formations, may be detected, and the path of motion of the AOV adjusted accordingly to avoid such obstacles. An inertial guidance sensor system 36 may be, for example, a Ferranti integrating accelerometer system that detects acceleration in the north and east geodetic directions and integrates the detected acceleration to determine change in geodetic position of the AOV 10 from the initial position entered into the navigation controller 14 at the time of deployment. U.S. Pat. No. 5,527,003 issued to Diesel et al. describes an example of an inertial guidance sensor system. In combination, the signals from the inertial guidance sensor system 36 and the pressure sensor P enables the navigation controller 14 to calculate the geodetic position of the AOV 10 in three dimensions at any time. The navigation controller 14 may be programmed to record the geodetic position thus calculated with respect to time, including navigation responses to detected obstacles, such that the actual geodetic path traversed by the AOV 10 may be determined when the AOV 10 is returned to the transport vessel (not shown) or other recovery location at the end of a seismic survey operation.

The AOV 10 may also include a seismic energy source, for example one or more marine seismic vibrators 32, 34 of any type known in the art. The seismic vibrators 32, 34 may be coupled to the underside of the housing 11, or otherwise towed by the AOV 10. The number of and type of seismic energy sources, e.g., marine vibrators, may be selected to provide seismic energy within a selected frequency range, and the vibrators 32, 34 may be pressure compensated to enable the vibrators 32, 34 to operate at substantial water depth, depending on, among other factors, the thickness of the layer of ice (not shown). The device drivers 16 may also be configured to cause operation of the marine seismic vibrators 32, 34 at selected, pre-programmed times and in preselected operating patterns, for example chirps or other swept frequency patterns. Marine vibrators may be preferred in the present example because there would be no requirement to provide a source of compressed air (for air guns) or compressed water (for water guns) and associated pressure compensation to enable gun type seismic energy sources to operate at variable water depths.

In one example, the marine seismic vibrators 32, 34 may be configured as described in U.S. Pat. No. 7,551,518 issued to Tenghamn and commonly owned with the present invention. Possible advantages of using vibrators as disclosed in the '518 patent are relatively high amplitude seismic signal output because the structure of such vibrators provides two resonance frequencies within a seismic frequency range of interest. Two or more such vibrators may be used to provide a relatively broad frequency range of seismic energy.

FIG. 2 shows an example of an autonomously operated seismic sensor array 50.

The array 50 maybe towed by same AOV as shown in FIG. 1, or by a different (second) AOV 10A as shown in FIG. 2. While certain details of the AOV 10A shown in FIG. 2 are omitted for clarity of the illustration, the second AOV 10A may be configured substantially the same as the AOV described above with reference to FIG. 1. If used to two the sensor array 50, the second AOV 10A need not include seismic energy source(s) (e.g., marine vibrators), however, as these may be coupled to or towed by the AOV shown in and explained with reference to FIG. 1. The second AOV 10A may include, as shown in FIG. 2, its own power source 17 (e.g., fuel cells, batteries or the like), navigation controller (not shown separately), position sensors (explained with reference to FIG. 1) navigation controllers and device drivers, shown collectively at 15. In the present example the second AOV 10A may include a seismic data recording unit 13. The recording unit 13 is configured to make time indexed records of signals detected by seismic sensors 44 deployed on one or a plurality of seismic streamers 42 towed by the second AOV 10A. If only one AOV is used to move both the seismic energy sources (FIG. 1) and the sensor array 50, the recording unit 13 may be disposed in such AOV or at some other convenient position within the sensor array 50.

The seismic streamers 42 may be conventionally configured seismic streamers, with any necessary modifications needed to enable the streamers 42 to operate at substantial water depth, e.g., pressure compensation devices (not shown). The streamers 42 may be coupled to the second AOV 10A using conventional streamer towing devices known in the art, including paravanes 40 that cause the streamers 42 to maintain selected lateral spacing behind and with respect to the centerline of the AOV 10A.

The streamers 42 in the present example may be maintained in a selected geometry by using lateral force and depth (LFD) control devices 48 disposed at selected positions along each streamer 42. A non-limiting example of such LFD control devices is described in U.S. Patent Application Publication No. 2009/0003129 filed by Stokkeland et al., the underlying patent application for which is commonly owned with the present invention. The streamers 42 may also include position sensors 46 to enable determination of the relative positions of the streamers 42 with respect to a selected reference. One example of such sensors and a system using such sensors is described in U.S. Pat. No. 7,376,045 issued to Falkenberg et al. and commonly owned with the present invention. Relative positions of the streamers 42 as determined using the position sensors 46 may be communicated to the navigation controller (forming part of the combined control and driver devices 15) in the second AOV 10A such that the geodetic position of each seismic sensor 44 may be determined at any time, and such position information may be recorded by the recording unit 13. Thus, recordings of seismic signals detected by the seismic sensors 44 may be indexed both with respect to time and geodetic position.

The navigation controller (part of 15 in FIG. 2) in the second AOV 10A may be programmed, for example, to track the geodetic path of the AOV shown at 10 in FIG. 1 and to follow at a selected distance therefrom. It is within the scope of the present invention for the various seismic sensor array devices, including the streamers 42, sensors 44, LFD control devices 48, position sensors 46 and recording unit 13 to be associated with the same AOV shown in FIG. 1 that transports the marine seismic vibrator(s) (shown at 32, 34 in FIG. 1). Therefore, the use of two (or more) separate AOVs for source transport and seismic sensor array transport is not a limit on the scope of the present invention.

The pre-programming of the navigation controller(s) (e.g., 14 in FIG. 1 and part of 15 in FIG. 2) may be arranged to cause the AOV(s) to return to the transport vessel (not shown in the Figures) or other recovery location after completion of the seismic survey operation. At such time or at any other time after completion of the survey operation, the recording unit 13 may be interrogated to obtain the recorded seismic signals for further processing according to methods well known in the art.

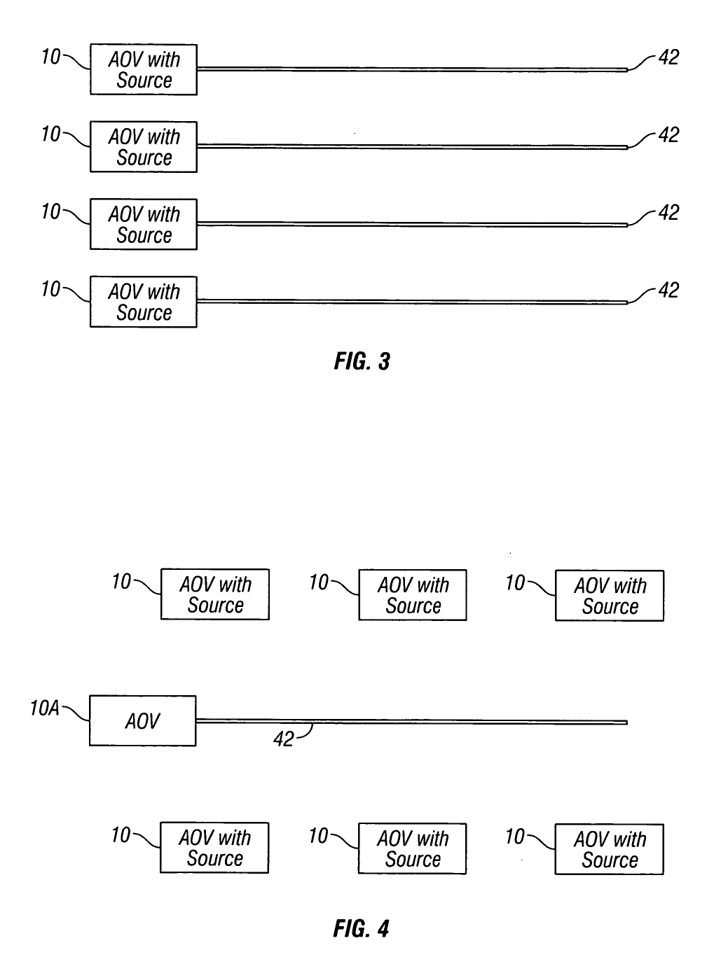

FIG. 3 shows another possible arrangement of multiple AOVs. The example shows for AOVs 10 configured as explained with reference to FIG. 1 and may include one or more seismic energy sources as explained above. Each of the AOVs tows a streamer 42. The streamer 42 may be configured as explained with reference to FIG. 2. In the present example, each AOV 10 may include signal recording devices as explained with reference to FIG. 2.

FIG. 4 shows a different example, wherein an AOV 10A configured as explained with reference to FIG. 2 tows a single seismic streamer 42. The streamer 42 may be configured as explained with reference to FIG. 2. A plurality of AOVs 10, configured as explained with reference to FIG. 1, each including one or more seismic energy sources (FIG. 1) may operate in a selected arrangement with respect to the streamer towing AOV 10A to provide a selected seismic data acquisition geometry. The examples explained above may provide more effective operation because of the limited amount of equipment towed by each AOV that has large dimension transverse to the direction of motion of the AOV as the example of FIG. 2. However, the arrangements of towed equipment and/or seismic energy sources shown in any of FIGS. 2, 3 and 4 are not intended to limit the scope of the present invention. In any of the arrangements explained with reference to FIGS. 3, and 4, at selected times the one or more seismic energy sources (e.g., marine vibrators) are actuated, and signals detected by the seismic sensors on the one or more streamers may be recorded.

A seismic survey acquisition system according to the various aspects of the invention may enable obtaining marine seismic survey information in locations, e.g., under ice, that are not accessible by marine seismic survey systems known in the art.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

1. A seismic survey system, comprising:
at least one autonomously operated vehicle;
at least one marine seismic vibrator associated with the autonomously operated vehicle;
wherein the autonomously operated vehicle includes a controller capable of operate operating the at least one marine seismic vibrator at selected times and to cause causing the autonomously operated vehicle to automatically follow a first predetermined geodetic path; and
at least one seismic streamer towed by at least one of the autonomously operated vehicle and a second autonomously operated vehicle, the seismic streamer comprising at least one device selected from the group of devices comprising: a pressure compensation device, a lateral force and depth control device, a position sensor, and any combination thereof.

2. (canceled)

3. The system of claim 1 further comprising a signal recorder associated with at least one of the autonomously operated vehicle and the second autonomously operated vehicle, the signal recorder configured to make time indexed recordings of seismic signals detected by one or more sensors in the at least one seismic streamer.

4. The system of claim 1 further comprising an obstacle detection sensor associated with the autonomously operated vehicle, wherein the controller is programmed to capable of change changing a direction of motion of the autonomously operated vehicle in response to detection of an obstacle.

5. The system of claim 1 further comprising an inertial navigation sensor system in signal communication with the controller.

6. The system of claim 1 further comprising a sensor responsive to water depth in signal communication with the controller.

7. The system of claim 1 wherein the autonomously operated vehicle comprises a housing defining a pressure sealed chamber, the housing comprising a ballast tank configured to provide the autonomously operated vehicle with substantially neutral buoyancy.

8. (canceled)

9. The system of claim 1, wherein the controller is configured to cause the at least one seismic streamer to travel substantially along the selected a second predetermined geodetic path.

10. The system of claim 1 further comprising at least one additional autonomously operated vehicle, wherein each of the autonomously operated vehicles towing tows a seismic streamer, and at least one each of the autonomously operated vehicle vehicles arranged to move is capable of moving a seismic energy source associated therewith.

11. The system of claim 1 further comprising a plurality of additional autonomously operable operated vehicles each having at least one seismic energy source associated therewith, each configured to follow a predetermined geodetic path associated therewith.

12. A method for seismic surveying, comprising:
moving a first autonomously operated vehicle in a body of water automatically along a predetermined geodetic path, the autonomously operated vehicle towing a seismic streamer therefrom;
moving one or more second autonomously operated vehicles in a selected pattern automatically with respect to the first autonomously operated vehicle and substantially simultaneously therewith, each of the second autonomously operated vehicles moving a marine seismic vibrator therewith, wherein each of the first and each second autonomously operated vehicles includes a controller capable of causing the autonomously operated vehicle to follow a predetermined geodetic path associated therewith;
actuating the marine seismic vibrator on at least one of the second autonomously operated vehicle vehicles at selected times; and
recording signals generated by seismic sensors in the seismic streamer, wherein the seismic streamer comprises at least one device selected from the group of devices comprising: a pressure compensation device, a lateral force and depth control device, a position sensor, and any combination thereof.

13. (canceled)

14. The method of claim 12 wherein at least one marine seismic vibrator comprises a plurality of marine seismic vibrators selected such that seismic energy is generated therefrom in a selected frequency range.

15. A method for seismic surveying, comprising:
moving a plurality of autonomously operated vehicles in a body of water substantially simultaneously automatically along a corresponding plurality of predetermined geodetic paths associated therewith, each autonomously operated vehicle towing a seismic sensor streamer therefrom, each autonomously operated vehicle moving a marine seismic vibrator therewith, each autonomously operated vehicle including a controller capable of causing the autonomously operated vehicle to follow the associated predetermined geodetic path;
actuating the marine seismic vibrator on at least one of the autonomously operated vehicle vehicles at selected times; and
recording signals generated by seismic sensors in each at least one seismic sensor streamer,
wherein each seismic streamer comprises at least one device selected from the group of devices comprising: a pressure compensation device, a lateral force and depth control device, a position sensor, and any combination thereof.

16. (canceled)

17. The method of claim 15 wherein at least one marine seismic vibrator comprises a plurality of marine seismic vibrators selected such that seismic energy is generated therefrom in a selected frequency range.

18. The system of claim 10 further comprising a signal recorder associated with at least one of the autonomously operated vehicles, the signal recorder configured to make time indexed recordings of seismic signals detected by one or more sensors in any of the seismic streamers.

19. The system of claim 11 further comprising a signal recorder associated with the autonomously operated vehicle, the signal recorder configured to make time indexed recordings of seismic signals detected by one or more sensors in the seismic streamer.

20. The method of claim 12 wherein moving the first autonomously operated vehicle in the body of water along the predetermined geodetic path comprises detecting geodetic position signals from a source of such signals.

21. The method of claim 15 wherein moving the plurality of autonomously operated vehicles in the body of water substantially simultaneously along the corresponding plurality of predetermined geodetic paths comprises detecting geodetic position signals from a source of such signals.
